(19) United States
(12) Patent Application Publication
(10) Pub. No.: US 2025/0307387 A1
(43) Pub. Date: Oct. 2, 2025

(54) TRANSFER LEARNING AND DEFENDING MODELS AGAINST ADVERSARIAL ATTACKS

(71) Applicant: Dell Products L.P., Round Rock, TX (US)

(72) Inventors: Pablo Nascimento da Silva, Niterói (BR); Roberto Nery Stelling Neto, Rio de Janeiro (BR)

(21) Appl. No.: 18/624,684

(22) Filed: Apr. 2, 2024

(51) Int. Cl. G06F 21/55

(52) U.S. Cl. CPC G06F 21/554; G06F 2221/033

(57) ABSTRACT

An automatic defense generator for transfer learning models using an ensemble model. Student models are provided with different defense layers configured to disrupt an adversarial attack. The accuracy of the defended student models is determined to select student models to include in an ensemble model. The accuracy of the ensemble model is compared with the initial accuracy of the student models. This allows the ensemble model to defend against adversarial attacks and perform its learned task without being fooled by compromised input.

### FIELD OF THE INVENTION

Embodiments of the present invention generally relate to transfer learning in machine learning models. More particularly, at least some embodiments of the invention relate to systems, hardware, software, computer-readable media, and methods for defending machine learning models trained with transfer learning from attacks including adversarial attacks.

### BACKGROUND

Deep neural networks (DNNs) models have been employed in various applications that include image classification, speech recognition, and image segmentation. Training a deep neural network model is not trivial. The training is both time-consuming and data intensive. In many applications, these characteristics often make training a deep neural network model from scratch impractical.

Transfer learning may be employed to overcome this challenge. Transfer learning relates to building useful models for a task by reusing a trained model for a similar but distinct task. In practice, for example, a handful of well-tuned and intricate models (teacher models) that have been pre-trained with large datasets are shared and available on public platforms. These models can be customized (student models) to create accurate models, at lower training costs, for specific tasks. A common approach to performing transfer learning is using the teacher model as a starting point and fine-tuning the teacher model for a specific task using a target dataset until the model achieves suitable accuracy using a very small and limited training dataset. The result of this type of transfer learning is a student model that is distinct from the teacher model.

The centralized nature of transfer learning presents an attractive and vulnerable target to attackers. Many teacher models, for example, are hosted or maintained on popular platforms, such as Azure, AWS, Google Cloud, and GitHub. Because highly tuned centralized models are publicly available, an attacker can explore their characteristics to create adversarial examples to fool the model, thereby creating security problems. In other words, the use of these models and their student models may be subject to serious security risks and can be fooled by compromised inputs.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of an example method for defending against attacks including adversarial attacks in machine learning models;

FIG. 2A discloses aspects of applying defenses to student models;

FIG. 2B discloses aspects of defenses to adversarial attacks including dropout pixel defenses;

FIG. 3 discloses aspects of a method for defending against adversarial attacks;

FIG. 4A discloses aspects of generating an ensemble model configured for defending against adversarial attacks;

FIG. 4B discloses aspects of pseudocode for generating an ensemble model and defending against adversarial attacks;

FIG. 4C discloses additional aspects of pseudocode for generating an ensemble model and defending against adversarial attacks; and

FIG. 5 discloses aspects of a computing device, system, or entity.

### DETAILED DESCRIPTION OF SOME EXAMPLE EMBODIMENTS

Embodiments of the present invention generally relate to defending against attacks in machine learning. More particularly, at least some embodiments of the invention relate to systems, hardware, software, computer-readable media, and methods for defending against adversarial attacks in transfer learning. More specifically, embodiments of the invention relate to protecting/defending machine learning models trained with transfer learning techniques from attacks including adversarial attacks.

A protection or defense mechanism is disclosed that protects student models automatically without having to retrain the student models. This is achieved, in one example, by developing or generating an ensemble of student models that can collectively prevent or reduce the likelihood that an adversarial attack will succeed.

Adversarial attacks often involve adding noise to an input such that the input to the model is classified incorrectly. Defenses are disclosed that disrupt the noise and thus prevent compromised input from fooling the model or reduce the likelihood of the compromised input fooling the model.

The defense includes preparing an ensemble model. The ensemble model may include multiple student models that may each include a defense layer. The defense layers are typically different and the ensemble model collectively provides a diverse defense.

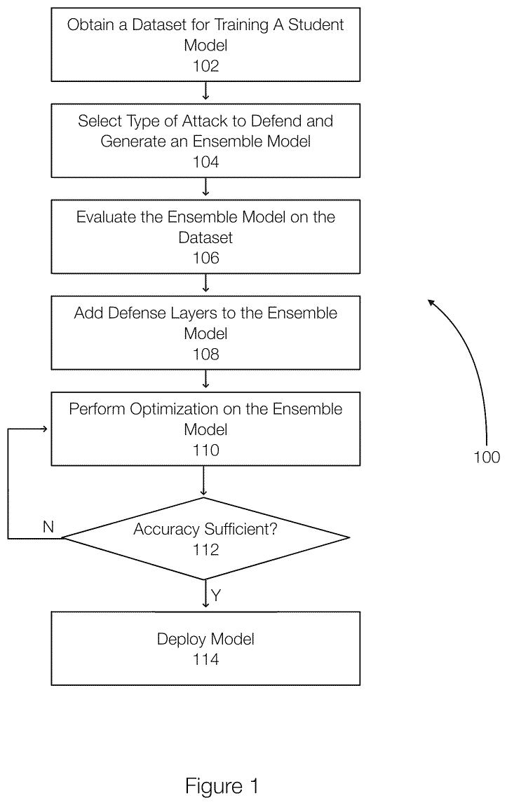

FIG. 1 discloses aspects of an example method for automatically defending against attacks including adversarial attacks in the context of transfer learning and student models. The method 100 includes obtaining 102 a dataset for training a student model or, in one example, an ensemble of student models. Multiple instances of the same student model are an example of an ensemble of models. Embodiments of the invention, however, may also relate to ensemble models that may include student models that are generated from different teacher models.

In transfer learning, a teacher model is selected and the teacher model is, in effect, converted to the student model by training or further customizing the teacher model using a training dataset. The training dataset allows the teacher model to be customized for a similar task and generating a student model in this manner from the teacher model leverages the training already performed on the teacher model.

Next, the type of attack to defend against is determined or selected 104. Attacks are generally referred to as adversarial attacks herein, but embodiments of the invention are not limited thereto. Adversarial attacks in the context of transfer learning can generally be placed in two categories. First, targeted attacks focus on modifying the classification output for a given input of the neural network to a specific output or specific classification. For example, the model may be fooled into predicting that an input image of a cat is classified as an image of a dog. In another example, the attacker may try to manipulate the model to change the prediction of the attacker's face to another user in order to maliciously gain access to another person's device. Second, untargeted attacks attempt to change the classification of a given input to any class different from the original class. This may disturb any application that leverages neural networks and relies on machine learning models.

Attacks can also be classified according to their access to a model's internal information. White-box attacks, for example, assume that the attacker has full access to the internal aspects of the deep neural network. For instance, the attacker may know the weights and architecture of the neural network in a white-box attack. Black-box attacks, in contrast, have no access to the internal aspects of the targeted deep neural network, but can query the target deep neural network to obtain information.

Adversarial attacks also have different flavors. A fast gradient sign method (FGSM) attack uses gradients of the neural network to create an adversarial example. For an input image, FGSM uses the gradients of the loss (J) with respect to the input image to build an adversarial example. More specifically, FGSM adds noise to the input image (X) in the direction of the gradient of the cost function (sign(∇_{X}J(X,Y))) with respect to the data (Y). The noise is scaled by a small multiplier ∈. The adversarial example may be able to fool the model where

$${X}_{Adversarial} = X + ϵ . sign ( {∇}_{X} J ( X , Y ) )$$

Unlike an FGSM attack, a mimicking attack is designed to be an attack on transfer learning. In one example of a mimicking attack, white-box access to a teacher model T and black-box access to a student model S are assumed. The attacker knows, in this example, that S was trained using T as a teacher and knows which layers were frozen when the student was trained.

In transfer learning, student models are created by customizing deep layers of a teacher model to a related task or the same task but with a different domain. A key insight of a mimicking attack is that, in feedforward networks, each layer can only observe what is passed on from the previous layer. If an internal representation of an adversarial sample (e.g., a perturbed image) at layer K perfectly matches the target image's internal representation at layer K, the adversarial sample must be misclassified into the same label or classification as the target image, regardless of the weights of any layers that follow K.

This type of attack, for example, allows an image to be misclassified (e.g., an image of a cat is misclassified as an image of a dog). This is achieved by perturbing the source image (image of the cat) to mimic the output of the K-th layer of the target image. This perturbation is computed in one example by solving the following optimization problem:

min D(T_{K}(xₛ^{J}),T_{K}(xₜ))

s.t.d(xₓ^{J},xₛ)<P.

This optimization minimizes a dissimilarity D(.) between the two outputs of the K-th hidden-layer, under a constraint to limit perturbation within a budget P.

The forgoing attacks are examples of adversarial attacks and embodiments of the invention can be configured to defend against these and other types of attacks. Thus, the type of attack to defend is selected 104 and an initial ensemble model may be generated. The ensemble model may be configured to defend against multiple types of attacks. The ensemble model may include a set of student models, each configured to defend against an adversarial attack.

Next, the ensemble model is evaluated 106 on the training dataset. More specifically, an initial accuracy (acc_initᵢ) of the ensemble model may be determined using the training dataset. Once the initial accuracy of the ensemble model is determined, a protection layer or defense layer may be added 108 to the ensemble model. More specifically, each of the student models in the ensemble model may be associated with a defense layer.

In one example, different defense layers may be added to the student models in the ensemble model. The defense layers are configured to alter the input to the student models in the ensemble model. In the context of a student model configured to perform image segmentation, the input may include images. The defense layer operates on (e.g., changes) the image and changes (e.g., drops out, zero) various pixels from one or more channels (e.g., R,G,B) of the input image.

An optimization is performed 110 on the ensemble model to adjust the manner in which pixels are changed in one example. Alternatively, the models included in the ensemble model may be changed (e.g., additional models may be added to the ensemble model, models may be removed). After performing an optimization operation, the accuracy (acc_def_{d}) of the ensemble model is evaluated 112 using compromised images. If the accuracy of the ensemble model is sufficiently close (e.g., acc_def_{d}+ε≥acc_initᵢ) to the initial accuracy of the unprotected or initial model (Y at 112), then the ensemble model may deployed 114. Otherwise (N at 112), the ensemble model is changed and aspects of the method 100 are repeated. For example, if the model accuracy does not improve, more student models may be added to the ensemble model, defenses may be reconfigured, or the like. This may be repeated until sufficient accuracy is achieved in the ensemble model.

Embodiments of the invention can defend transfer learning models from adversarial attacks automatically before deploying the models to production by generating and deploying an ensemble model. This is achieved by building an ensemble model based on a set of adversarial attacks. In addition, embodiments of the invention include a reload and deploy a module that allows for defenses to new attacks to be added to the ensemble model.

Embodiments of the invention are discussed in the context of image segmentation tasks and models configured to segment an image by way of example only, but are not limited to these specific models. Generally, embodiments of the invention receive an initial configuration of a model (e.g., a teacher model) and a dataset for a target image segmentation task and a student model may be generated. The dataset, in this example, is the same dataset used in the transfer learning training process. Next, at least one type of attack is identified.

With this initial configuration, embodiments of the invention evaluate the accuracy of the initial model. The initial accuracy may be used later to check whether the ensemble model is resilient against the attacks. Next, the ensemble model is built by creating a pool of models. Each model in the pool of models may be provided with a defense layer, which may all be different in one example. Example defenses include dropout pixel defenses. These defenses are evaluated and an ensemble model is assembled based on the best performing individual instances of the model.

More specifically, an optimizer is executed to select the best ensemble configuration that maximizes the final accuracy on the target task conditioned by the adversarial attacks. The accuracy of the optimized ensemble is determined. If the accuracy of the ensemble model is greater than the accuracy of the initial model or within an acceptable threshold of the initial accuracy, then the model may be deployed. If the accuracy of the ensemble model is lower than the initial model, the process is repeated (e.g., k times) in order to build more models to improve the ensemble model and the ensemble model is optimized again.

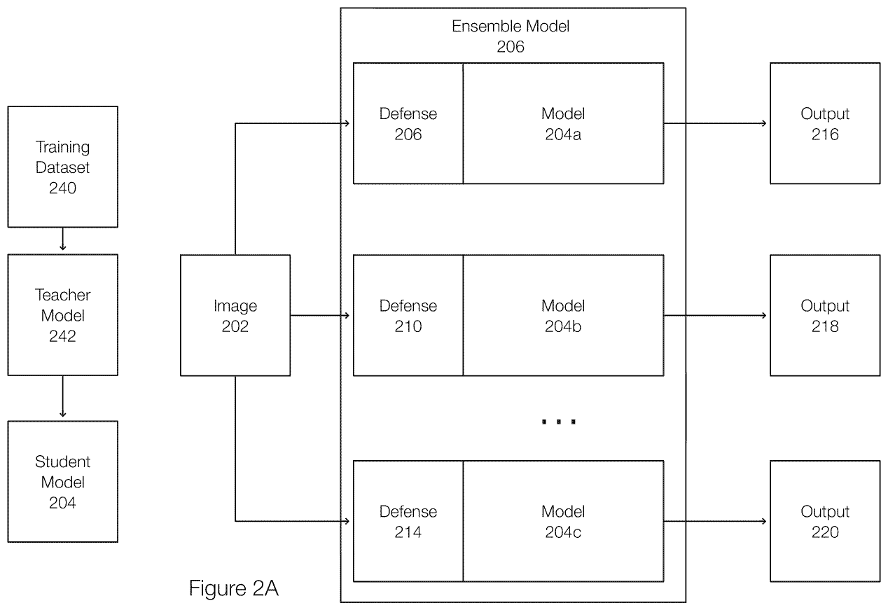

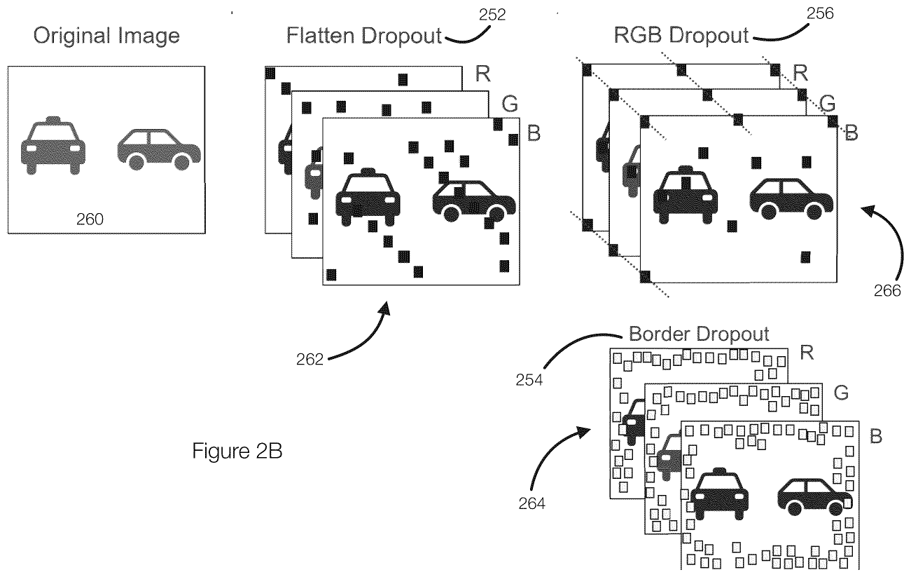

FIG. 2A discloses aspects of applying defenses to student models in an ensemble model. FIG. 2A illustrates models 204a, 204b, and 204c. The models 204a, 204b, and 204c are instances of the same student model 204, which was generated using a training dataset 240 and a teacher model 242. In this example, the student model 204 was generated by transfer learning.

In this example, defenses have been applied to the models 204a, 204b, and 204c. The defenses are represented as defenses 206, 210, and 214. The defenses 206, 210, and 214 are different. In one example, the defenses 206, 210, and 214 are each a different version of a dropout pixel defense. The defenses 206, 210, and 214 are applied to the image 202 as the image is input to the models 204a, 204b, and 204c. Thus, the image 202 is changed or altered according to the defense being applied. The outputs 216, 218, and 220 may be evaluated to measure the accuracy of the ensemble model 206. The accuracy may be evaluated using attacked or compromised images or input.

As previously stated, a transfer attack is often performed by attacking the image 202. In one example of an attack, noise may be added in a manner that causes the student model 204 to incorrectly classify the input image, incorrectly segment the image, or the like. This allows, as previously stated, an attacked image of a cat that includes the appropriate noise to be classified as an image of a dog or causes a stop sign to be interpreted as something other than a stop sign.

Embodiments of the invention are configured to apply the defenses 206, 210, and 214 to build an ensemble model 206 that includes the models 204a, 204b, and 204c and/or the defenses 206, 210, and 214. The ensemble model 206 is more resilient to adversarial attacks.

Embodiments of the invention defend against adversarial attacks by dropping pixels of the original input. Dropping pixels can interfere with the adversarial attack because the noise added by the adversarial attack is, in effect, changed. At the same time, embodiments of the invention ensure that the attacked image, after applying the defenses, can still be classified correctly. Embodiments of the invention combine attacks and defenses to generate an ensemble model 206 that can still generate predictions that are suitable for the target task. The goal is to drop the correct combination of pixels to prevent the attack from succeeding while also allowing the model to generate an accurate prediction or inference or classification.

FIG. 2B discloses examples of defenses to adversarial attacks including dropout pixel defenses. FIG. 2B illustrates an original image 260. The images 262, 264, and 266 represent the image 260 after applying defenses 252, 254, and 256. More specifically, the images 262, 264, and 266 illustrate the R, G, and B channels after the defense has been applied.

In this example, the images 262, 264, and 266 are modified by the defenses 252, 254, and 256, which correspond to the defenses 206, 210, and 214 in one example.

FIG. 2B more specifically illustrates a flatten dropout defense 252, an RGB (Red, Green, Blue) dropout defense 256, and a border dropout defense 254. The defense 252 is performed by removing a percentage (d) of pixels from the original image 26 from each of the R, G, and B channels. The percentage (d) can vary. In this example of the defense 252, the pixels removed from the R channel are different from the pixels removed from the B and G channels. Similarly, the pixels removed from the G channel are different from the pixels removed from the R and B channels. This is illustrated in the RGB images 262.

The dropout defense 256 removes a percentage d of pixels from each of the R, G, and B channels. In this example, the same pixels in each of the R, G, and B channels are removed as illustrated in the R, G, and B channels 266.

The border dropout defense 254 drops or removes pixels at or in a border area of the image 260 as illustrated by the R, G, B channels 264. The defense 254 may drop pixels aggressively (5% of pixels) in part because images often have a centrality bias, which suggests that important classes are usually located near the center of the image and most attack techniques add noise to the whole image. As a result, a significant part of the noise signal can be impacted without burdening the image.

The defenses 252, 254, and 256 have been described by way of example and embodiments of the invention are not limited to these defenses. In addition to dropout pixels, additional noise may be added to an image as a defense. More generally, the defenses are configured to interfere with the noise added to the attacked image in an attempt to reduce the intended impact of the noise, thereby preventing attacked images from being classified or interpreted incorrectly.

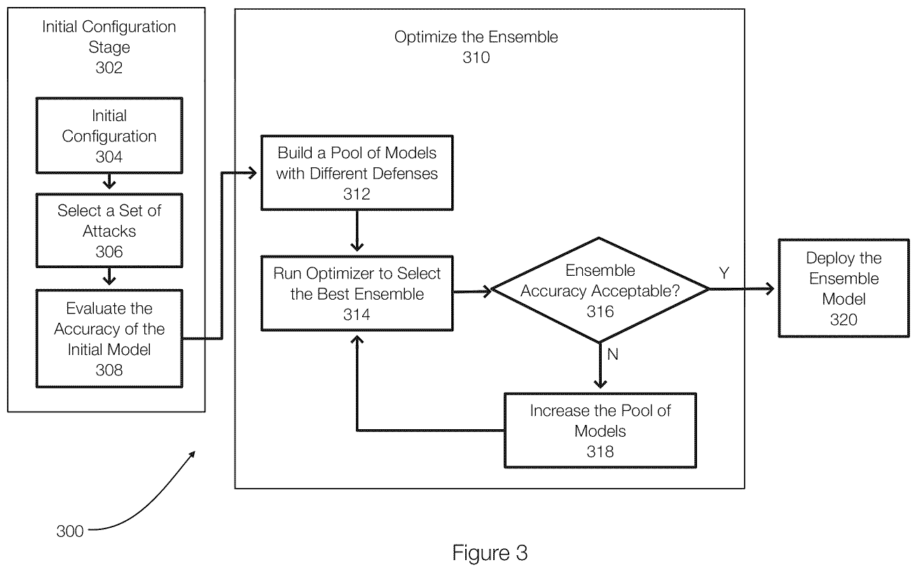

FIG. 3 discloses aspects of a method for defending a model against attacks including adversarial attacks. The method 300 includes an initial configuration 302 stage, an optimization stage (optimize the ensemble 310) and a deployment stage (deploy the ensemble model 320).

The initial configuration 302 includes determining an initial configuration 304. The initial configuration may include selecting 306 a set of attacks to be defended against. Other aspects of the initial configuration 304 may include selecting a list of defenses to apply, obtaining a list of student models, determining a size of an ensemble pool from which the ensemble model is constructed, setting a maximum number of models that can be included in the final ensemble model, determining how results of the student models are aggregated, and identifying a dataset for the target task.

Once the configuration is determined, the accuracy of the student models is determined or evaluated 308. The accuracy is typically determined with respect to a training dataset identified in the initial configuration 302 or other dataset. Evaluating 308 the accuracy of the initial model includes evaluating or determining an initial accuracy of each of the student models in the target dataset (acc_init_{s,0}) if necessary and the attack accuracy of the model s with defenses against each attack a (acc_init_{s,a}). Each model j is combined with either a defense of a selected attack (a∈Â) or has no defense (e.g., marked as subscript 0, (acc_init_{s,0}).

More specifically, each of the student models is associated with a first accuracy related to passing a training image through the model with no defense and a second accuracy related to passing an attacked image through the defense and the model.

In another example, the training images (unattacked images) may be passed through the defense and the model to validate the accuracy results and determine whether the defenses are degrading the accuracy of the model when not attacked. In another example, one of the attacks in the set of attacks may be an unattacked image. In both instances, these embodiments may also ensure that the ensemble model is prepared for its intended task.

Next, the ensemble model is optimized 310. Optimizing 310 the ensemble is performed to find a suitable or optimal ensemble model to protect the task being performed (e.g., image segmentation). Optimizing the ensemble model may include building 312 a pool of models with different defenses. The attacked images are input to a set of models selected from the pool and an optimizer is run 314 to identify the best ensemble model. If the accuracy of the ensemble model is acceptable (Y at 316), the ensemble model may be deployed 320. If the accuracy of the ensemble model is not acceptable or outside the threshold (N at 316), the number of models in the pool of models is increased and the optimizer is run 314 again. This may continue until the accuracy of the ensemble model is sufficient.

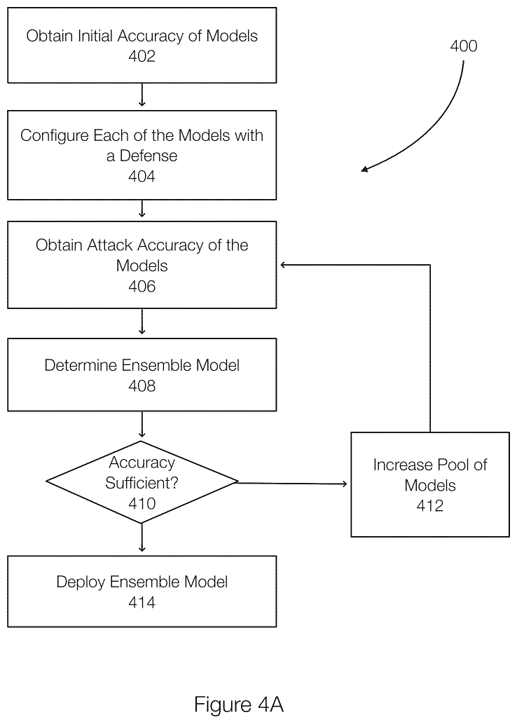

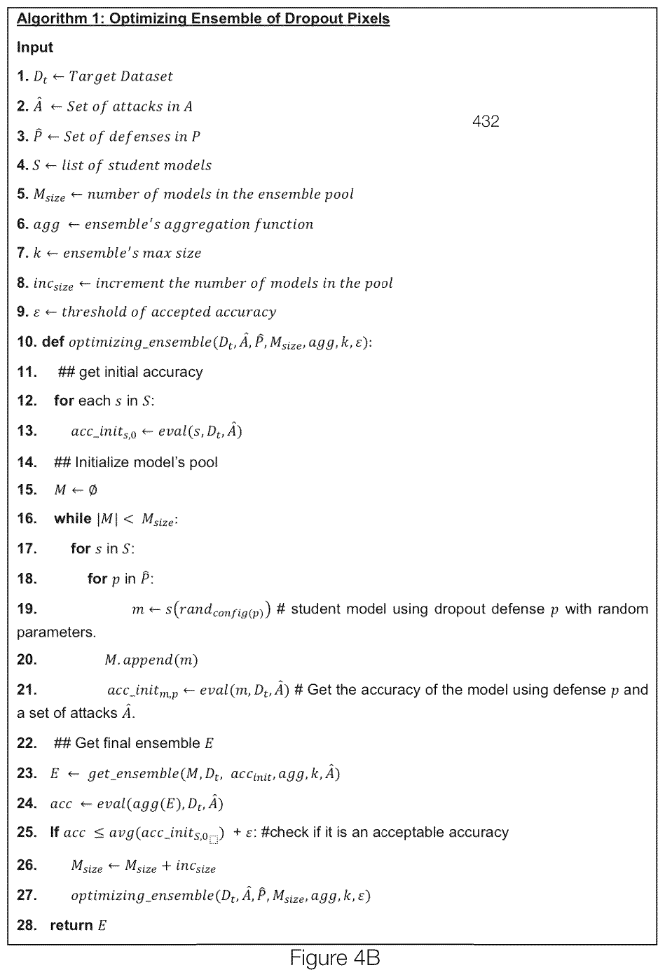

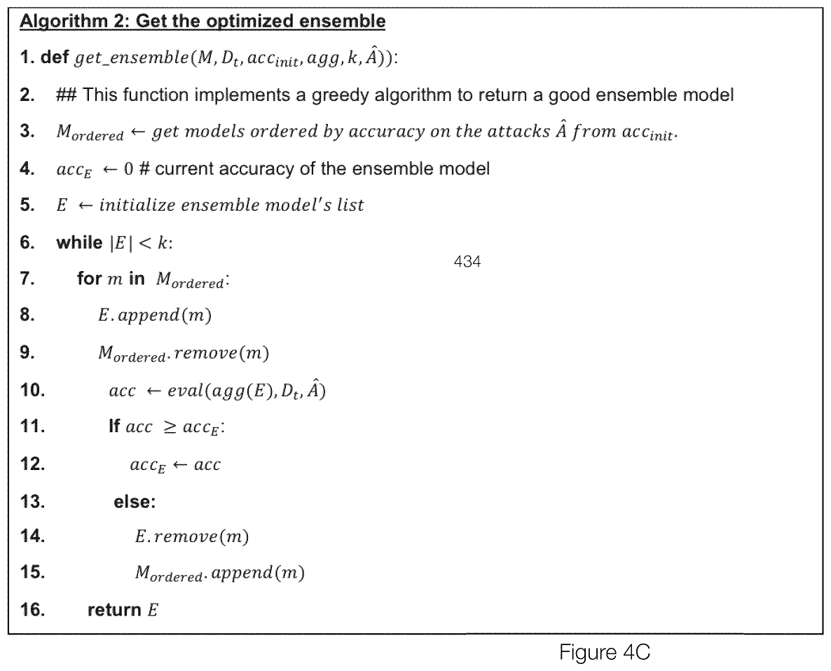

FIG. 4A illustrates aspects of generating/optimizing an ensemble model. The method 400, which may overlap with aspects of the method 300, assumes that an initial confirmation has been determined. For example, the following configuration is determined:
a selection of a set of attacks (Â∈A) to be applied and defended against;
a list of defenses using dropout pixels (\hat{P}∈P);
a list of student models S;
a total number of models (M_{size}) in the ensemble pool M;
configurations about the optimization procedure;
a maximum number of models in the final ensemble k;
an aggregation function (agg) to combine the results of the ensemble; and
a dataset from the target task (Dₜ).

The method 400 obtains 402 an initial accuracy of the student models. Once the initial accuracy is determined, each of the student models is configured 404 with a defense. When configuring the models with a defense, the defense may be randomly configured. For example, the percentage of pixels to drop, the selection of channels in which pixels are dropped, the type of pixel drop, and the like may be set randomly.

Once the models are configured with a defense accuracy, the attack accuracy of the models is determined or obtained 406. This may include inputting compromised input (e.g., images) that have been compromised or attacked. In one example, the dataset used for training are altered to be an attack dataset and input to the models. The attack accuracy thus represents how well the defended models can handle the attack being defended. For example, if an image of a cat is compromised such that a model predicts that it is an image of a dog and the model with the defense is able to correctly predict that the image is of a cat, then the defense is functioning.

Once the attack accuracy is determined for each of the models is determined, an ensemble model is determined 408. This may include selecting a subset of the models being tested or evaluated that have the best accuracies. Once the models to include in the ensemble model are identified, the accuracy of the ensemble model is determined. This may include generating an aggregated accuracy or by combining the accuracies of the individual models in a certain manner (e.g., taking an average accuracy of the models in the ensemble model).

If the accuracy of the ensemble model is sufficient (e.g., within a threshold of the unattacked accuracy), the ensemble model may be deployed 414. If the accuracy of the ensemble model is not sufficient, additional models may be added and the method returns to obtaining 406 the attack accuracy of the models. Repeating the optimization process allows various defense configurations to be determined, optimized or tested until the accuracy of the ensemble model is sufficient and an attacked image is unlikely to fool the ensemble model.

FIG. 4B illustrates pseudocode of a method for optimizing an ensemble model and is reflected in FIGS. 3 and 4A. FIG. 4B illustrates an example of pseudocode 432 for optimizing an ensemble model. For example, lines 1-9 relate to determining some of the configuration inputs. Once the optimization operation is initialized with these inputs or parameters, the accuracies of the student models are determined in lines 11-13 of the pseudocode 432.

After the initial accuracies have been determined or obtained, a model pool from which the ensemble model will be built is initialized in lines 15-21. This may include a random configuration of a defense p together with a student model s from the model pool using the function rand_{config} in line 19. In line 21, the accuracy of the models using the configured defenses and attacks are determined.

FIG. 4C discloses aspects of selecting the models to include in the ensemble model. In line 23 of the pseudocode 432, the pseudocode 434 is called. The pseudocode 434 prioritizes the models with the best accuracy. More specifically in one example, the pseudocode 434 implements a greedy algorithm to select the models to include in the ensemble model. The ensemble model is returned and its accuracy is determined in line 24.

Lines 25-27 of the pseudocode 432 define a re-execution procedure whenever the accuracy threshold achieved by the optimization operation is not achieved. Once, the required accuracy is achieved, the ensemble model is returned in line 28.

Once approved, the ensemble model may be deployed to production and is capable of defending against adversarial attacks. Thus, after the selection of the best ensemble model, based on the optimizing operation, to defend against the selected attacks the model is encapsulated and sent to production. The state of the optimization process may be saved such that the state can be reinitialized if there is a need to optimize the ensemble model for a new type of attack. Saving the state may include saving the types of defenses uses and their accuracy when applied to each type of model. This information can be used as a starting point for optimizing the model again for a new type of attack.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, model defense operations, model ensemble selection/building operations, ensemble model optimization operations, or the like. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable perform operations initiated by one or more clients or other elements of the operating environment.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments may be employed include, but are not limited to, Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ is intended to be broad in scope. Example embodiments are applicable to any system capable of storing and handling various types of objects, in analog, digital, or other form.

It is noted that any operations of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method comprising: determining an initial accuracy for models in a pool of models using a dataset, configuring each of the models with a defense to an attack;
determining an attack accuracy for each of the models using an attack dataset, selecting a set of the models for an ensemble model based on the attack accuracies, determining an aggregate accuracy of the ensemble model, and deploying the ensemble model when the aggregate accuracy is at least within a threshold of the initial accuracy and performing an optimization loop when the aggregate accuracy outside the threshold.

Embodiment 2. The method of embodiment 1, wherein the defense is configured to disrupt the attack.

Embodiment 3. The method of embodiment 1 and/or 2, wherein the attack includes noise added to the dataset, wherein the defense is configured to prevent the attack from succeeding by altering the noise.

Embodiment 4. The method of embodiment 1, 2, and/or 3, wherein the dataset includes images, wherein the defense is configured to alter pixels in the images.

Embodiment 5 The method of embodiment 1, 2, 3, and/or 4, wherein the defense is configured to drop out different pixels in each of an image's channels, is configured to drop a same pixels in the image's channels, or drop pixels in an image's border.

Embodiment 6. The method of embodiment 1, 2, 3, 4, and/or 5, further comprising initializing the ensemble model with a target dataset, a set of attacks, a set of defenses, a list of student models, a maximum number of models in a pool of models, and a threshold accepted accuracy.

Embodiment 7. The method of embodiment 1, 2, 3, 4, 5, and/or 6, wherein the optimization loop includes adding models to the pool, determining an attack accuracy for the models in the pool and generating a new ensemble model.

Embodiment 8 The method of embodiment 1, 2, 3, 4, 5, 6, and/or 7, further comprising generating the attacking dataset.

Embodiment 9. The method of embodiment 1, 2, 3, 4, 5, 6, 7, and/or 8, further comprising randomly configuring the defense applied to each of the models, wherein the configuration of the defense includes a percentage of pixels, a type of drop out, and a channel selection.

Embodiment 10. The method of embodiment 1, 2, 3, 4, 5, 6, 7, 8, and/or 9, wherein the attack is an adversarial attack, wherein each of the models is configured with a different defense and wherein the ensemble model is configured to defend against one or more attacks.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

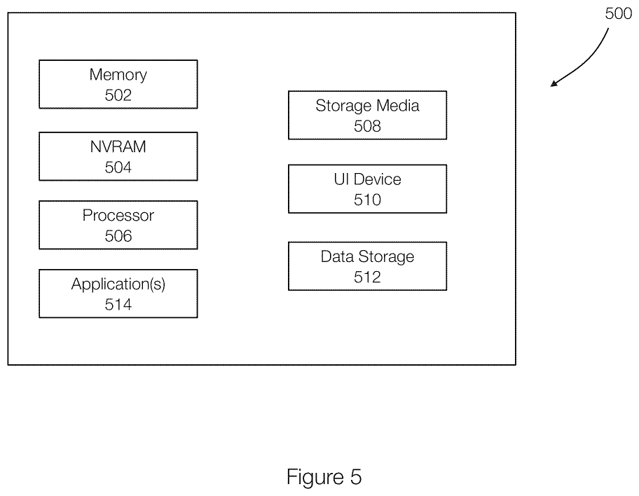

With reference briefly now to FIG. 5, any one or more of the entities disclosed, or implied the Figures and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method comprising:
determining an initial accuracy for models in a pool of models using a dataset;
configuring each of the models with a defense to an attack;
determining an attack accuracy for each of the models using an attack dataset;
selecting a set of the models for an ensemble model based on the attack accuracies;
determining an aggregate accuracy of the ensemble model; and
deploying the ensemble model when the aggregate accuracy is at least within a threshold of the initial accuracy and performing an optimization loop when the aggregate accuracy is outside the threshold.

2. The method of claim 1, wherein the defense is configured to disrupt the attack.

3. The method of claim 2, wherein the attack includes noise added to the dataset, wherein the defense is configured to prevent the attack from succeeding by altering the noise.

4. The method of claim 1, wherein the dataset includes images, wherein the defense is configured to alter pixels in the images.

5. The method of claim 4, wherein the defense is configured to drop out different pixels in each of an image's channels, is configured to drop a same pixels in the image's channels, or drop pixels in an image's border.

6. The method of claim 5, further comprising initializing the ensemble model with a target dataset, a set of attacks, a set of defenses, a list of student models, a maximum number of models in a pool of models, and a threshold accepted accuracy.

7. The method of claim 1, wherein the optimization loop includes adding models to the pool, determining an attack accuracy for the models in the pool and generating a new ensemble model.

8. The method of claim 7, further comprising generating the attacking dataset.

9. The method of claim 1, further comprising randomly configuring the defense applied to each of the models, wherein the configuration of the defense includes a percentage of pixels, a type of drop out, and a channel selection.

10. The method of claim 1, wherein the attack is an adversarial attack, wherein each of the models is configured with a different defense and wherein the ensemble model is configured to defend against one or more attacks.

11. A non-transitory storage medium having stored therein instructions that are executable by one or more hardware processors to perform operations comprising:
determining an initial accuracy for models in a pool of models using a dataset;
configuring each of the models with a defense to an attack;
determining an attack accuracy for each of the models using an attack dataset;
selecting a set of the models for an ensemble model based on the attack accuracies;
determining an aggregate accuracy of the ensemble model; and
deploying the ensemble model when the aggregate accuracy is at least within a threshold of the initial accuracy and performing an optimization loop when the aggregate accuracy outside the threshold.

12. The non-transitory storage medium of claim 11, wherein the defense is configured to disrupt the attack.

13. The non-transitory storage medium of claim 12, wherein the attack includes noise added to the dataset, wherein the defense is configured to prevent the attack from succeeding by altering the noise.

14. The non-transitory storage medium of claim 11, wherein the dataset includes images, wherein the defense is configured to alter pixels in the images.

15. The non-transitory storage medium of claim 14, wherein the defense is configured to drop out different pixels in each of an image's channels, is configured to drop a same pixels in the image's channels, or drop pixels in an image's border.

16. The non-transitory storage medium of claim 15, further comprising initializing the ensemble model with a target dataset, a set of attacks, a set of defenses, a list of student models, a maximum number of models in a pool of models, and a threshold accepted accuracy.

17. The non-transitory storage medium of claim 11, wherein the optimization loop includes adding models to the pool, determining an attack accuracy for the models in the pool and generating a new ensemble model.

18. The non-transitory storage medium of claim 17, further comprising generating the attacking dataset.

19. The non-transitory storage medium of claim 11, further comprising randomly configuring the defense applied to each of the models, wherein the configuration of the defense includes a percentage of pixels, a type of drop out, and a channel selection.

20. The non-transitory storage medium of claim 11, wherein the attack is an adversarial attack, wherein each of the models is configured with a different defense and wherein the ensemble model is configured to defend against one or more attacks.
